(19) United States
(12) Patent Application Publication
(10) Pub. No.: US 2023/0391635 A1
(43) Pub. Date: Dec. 7, 2023

(54) RADIALLY STRUCTURED NICKEL-BASED PRECURSOR AND PREPARATION METHOD THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Weiquan Li, Foshan (CN); Changdong Li, Foshan (CN); Dingshan Ruan, Foshan (CN); Yong Cai, Foshan (CN); Genghao Liu, Foshan (CN); Hongjia Lin, Foshan (CN)

(21) Appl. No.: 18/235,364

(22) Filed: Aug. 18, 2023

Related U.S. Application Data
(63) Continuation of application No. PCT/CN2022/092463, filed on May 12, 2022.

(30) Foreign Application Priority Data
Aug. 18, 2021 (CN) 202110948895.1

(51) Int. Cl. C01G 53/04; C01G 53/00

(52) U.S. Cl. CPC C01G 53/04; C01G 53/006; C01P 2004/03; C01P 2004/51; C01P 2004/61; C01P 2006/80

(57) ABSTRACT

The present invention discloses a radially-structured nickel-based precursor and a preparation method thereof. An overall shape of the precursor is a secondary sphere formed by agglomeration of primary crystal grains; and the secondary sphere has a loose and porous network core inside and uniform and regular strip primary crystal grains outside, and the strip primary crystal grains grow outward perpendicularly to a surface of the core and are arranged radially and closely. The precursor structure of the present invention is more suitable for high-power battery cathode materials. The internal loose structure is more likely to form a void in the center during a preparation process of a cathode material, which helps to expand a contact area between an active material and an electrolyte.

### CROSS-REFERENCE TO RELATED APPLICATIONS

The present application is a continuation application of PCT application No. PCT/CN2022/092463 filed on May 12, 2022, which claims the benefit of Chinese Patent Application No. 202110948895.1 filed on Aug. 18, 2021. The contents of all of the aforementioned applications are incorporated by reference herein in their entirety.

### TECHNICAL FIELD

The present invention belongs to the technical field of cathode material precursors, and specifically relates to a radially-structured nickel-based precursor and a preparation method thereof.

### BACKGROUND

In recent years, the global new energy electric vehicle (EV) industry has developed rapidly. A sales volume of global generalized new energy EVs reached 1.5 million in 2015, will be about 5 million by 2020, and is expected to reach 6 million and 8 million in 2021 and 2022, respectively, which leads to increasing demand for power batteries. Lithium-ion batteries (LIB s) are widely used in new energy vehicle power systems due to small size, high energy density, and excellent cycling performance. With the development of battery technology, pure EVs have increasing cruising ranges, but there are still varying degrees of range anxiety due to long charging time. At present, the development of hybrid electric vehicles (HEVs) or plug-in hybrid electric vehicles (PHEVs) and fast-charge technology is an important solution to the problem of EV range anxiety. In a hybrid system, a battery does not work continuously, but is charged and discharged rapidly under specified working conditions to provide high-power input and output, which presents advanced requirements on the power performance, cycling performance, and safety performance of LIB s.

In order to meet the requirements, a cathode material in LIB needs to have a large contact area with an electrolyte to achieve the efficient interface transmission of ions and electrons, a specified buffer structure is also required inside to cope with the volume expansion and contraction of a material during a charging and discharging process, and a crystal form of a material must have regular radial arrangement to achieve the shortest and the optimal transmission path of lithium ions. A nickel-based cathode material can meet the above requirements in a given situation. Generally, a precursor with the above characteristics is first prepared, then the precursor is mixed with a lithium salt, and a resulting mixture is subjected to high-temperature sintering to obtain a cathode material with the above structural characteristics through morphology inheritance.

The related art discloses a nickel-cobalt-manganese core-shell precursor and a preparation method thereof, and a cathode material. The precursor is prepared in stages by a batch process. In a nucleation stage, under fast stirring, crystal nuclei with a compact texture are prepared at an inert atmosphere, a low pH, and a high ammonia concentration; and in a second stage, under slow stirring, a loose shell is prepared at an oxidizing atmosphere, a high pH, and a low ammonia concentration to obtain precursor particles that are compact inside and loose outside and have radially-structured primary particles. A cathode material obtained from the precursor also inherits the morphological characteristics of the precursor, which is also compact inside and loose outside. This structure is not conducive to coping with the volume expansion and contraction of the cathode material during a charging and discharging process.

### SUMMARY OF THE INVENTION

The present invention is intended to solve at least one of the technical problems existing in the prior art. In view of this, the present invention provides a radially-structured nickel-based precursor and a preparation method thereof.

According to one aspect of the present invention, a radially structured nickel-based precursor is provided, where an overall shape of the precursor is a secondary sphere formed by aggregation of primary crystal grains; the secondary sphere has a loose and porous network-structured core inside, and has uniform and regular strip-shaped primary crystal grains outside, and the strip-shaped primary crystal grains grow outward perpendicularly to a surface of the core and are arranged radially and closely; and the precursor has a chemical formula of NiₓCo_{y}Mn_{z}M_{(1-x-y-z)}(OH)₂, where 0.5≤x<1, 0≤y≤0.5, 0≤z≤0.5, and M is a doping element.

In some implementations of the present invention, the precursor has an average particle size of 3-10 μm.

In some implementations of the present invention, a diameter of the core of the precursor accounts for more than ½ of a diameter of an entire precursor particle.

In some implementations of the present invention, the M is one or more selected from the group consisting of Al, Mg, W, Zr, and Ti.

The present invention also provides a preparation method of the radially structured nickel-based precursor, comprising the following steps:
(1) adding a metal solution, an alkali liquor, and ammonia water to a first reactor, and heating and stirring to allow a reaction to prepare a seed crystal; during the reaction, controlling the pH within a range of 9 to 12, and controlling an ammonia concentration in the reaction system at 0-5 g/L, and continuously feeding the metal solution, the alkali liquor, and the ammonia water to obtain a seed crystal having a particle size of a target value; and
(2) adding the seed crystal, the metal solution, the alkali liquor, and the ammonia water to a second reactor, and heating and stirring to allow a reaction, during the reaction, controlling the pH at 9 to 12, controlling an ammonia concentration in the reaction system at 5 10 g/L, and continuously feeding the metal solution, the alkali liquor, and the ammonia water to obtain a product having a particle size of a target value; and collecting, washing, dewatering, and drying the product to obtain the radially-structured nickel-based precursor;
wherein the metal solution comprises a nickel salt and one or two selected from the group consisting of a cobalt salt and a manganese salt.

In some implementations of the present invention, total metals in the metal solution may have a molar concentration of 1.0-2.5 mol/L.

In some implementations of the present invention, the metal solution comprises a doped metal salt, and the doped metal salt is one or more selected from the group consisting of aluminum sulfate, aluminum nitrate, sodium aluminate, magnesium sulfate, magnesium nitrate, magnesium chloride, sodium tungstate, tungsten trioxide, zirconium sulfate, zirconium nitrate, titanium chloride, titanic acid, and titanium tetrachloride.

In some implementations of the present invention, in step (1), the nickel salt is one or more selected from the group consisting of nickel sulfate, nickel nitrate, and nickel chloride.

In some implementations of the present invention, in step (1), the cobalt salt is one or more selected from the group consisting of cobalt sulfate, cobalt nitrate, and cobalt chloride.

In some implementations of the present invention, in step (1), the manganese salt is one or more selected from the group consisting of manganese sulfate, manganese chloride, and manganese nitrate.

In some implementations of the present invention, in step (2), when the particle size reaches the target value of the seed crystal, the pH is increased to make a new crystal nucleus, such that the size of the particles in the reactor can be always kept around the target value of the seed crystal. Further, a qualified seed crystal is collected and spin-dried to obtain a dry seed crystal, and the dry seed crystal may be sealed and stored. The method of adjusting a pH to form a new crystal nucleus can realize the continuous production of a seed crystal, and ensure uniform internal structure, simple control, and stable process. A dry seed crystal can be easily stored and fed, which can save equipment investment and simplify a production process and is more suitable for large-scale mass production.

In some implementations of the present invention, in step (2), when the particle size reaches the target value of the precursor, the seed crystal is fed while overflowing to maintain a solid content in the reactor relatively stable, such that a particle size of the precursor in the reactor can be always kept around the target value. The method of feeding a dry seed crystal while overflowing makes a total solid content in the reactor unchanged, a particle size distribution in the reactor unchanged, and a synthesis environment very stable, which can ensure that primary crystal grains grow radially and closely on the surface of the seed crystal, and can also realize the continuous production and ensure uniform internal structure, simple control, and stable process.

In some implementations of the present invention, in steps (1) and/or (2), the heating is conducted at 50-80° C.

In some implementations of the present invention, in step (2), the added alkali liquor has a mass fraction of 15% to 35%. Further, the alkali liquor is a sodium hydroxide solution.

In some implementations of the present invention, in step (2), the added ammonia water has a mass fraction of 10% to 30%.

In some implementations of the present invention, the target particle size of the seed crystal is not less than ½ of the target particle size of the precursor.

According to a preferred implementation of the present invention, the present invention at least has the following beneficial effects:
1. The radially-structured nickel-based precursor of the present invention has an internal loose network structure and an external radial structure, and is more suitable for high-power battery cathode materials. The internal loose structure is more likely to form a void in the center during a preparation process of a cathode material, which helps to expand a contact area between an active material and an electrolyte. The combination of the hollow structure and the radially-structured crystal grains shortens a transmission path of Li ions in the material, and can alleviate a deformation stress caused by the volume expansion and contraction of particles in a macrostructure, which is conducive to improving the cycling performance of a battery material.
2. Precursor particles can form a regular radial structure in a very stable environment with a proper supersaturation, and will grow into a messy and loose network structure in an unstable environment (a supersaturation fluctuates high and low). In the seed crystal preparation stage of the present invention, low-ammonia complexation is conducted, during which a pH fluctuates up and down, and the unstable growth environment leads to the formation of a network nucleus; and in the seed crystal growth stage, high-ammonia complexation is conducted at a stable pH, such that crystal grains can grow stably and regularly, thereby resulting in a core-shell structure with an internal loose network and an external uniform radial structure.

### BRIEF DESCRIPTION OF THE DRAWINGS

The present invention is further described below with reference to accompanying drawings and examples.

FIG. 1 is a schematic structural diagram of the precursor of Example 1 of the present invention;

FIG. 2 is a scanning electron microscopy (SEM) image of the precursor of Example 1 of the present invention;

FIG. 3 is an SEM image of a cross-section of the precursor of Example 1 of the present invention;

FIG. 4 is an SEM image of the precursor of Comparative Example 1 of the present invention; and

FIG. 5 is an SEM image of a cross-section of the precursor of Comparative Example 1 of the present invention.

### DETAILED DESCRIPTION OF ILLUSTRATED EXAMPLES

The concepts and technical effects of the present invention are clearly and completely described below in conjunction with examples, so as to allow the objectives, features and effects of the present invention to be fully understood. Apparently, the described examples are merely some rather than all of the examples of the present invention. All other examples obtained by those skilled in the art based on the examples of the present invention without creative efforts should fall within the protection scope of the present invention.

Relevant values of the seed crystal particle size and the precursor particle size mentioned in the examples all refer to an average particle size.

### Example 1

In this example, a radially-structured nickel-based precursor was prepared, and a specific preparation process was as follows:
(1) Preparation of feed solutions: Nickel sulfate, cobalt sulfate, and manganese sulfate were mixed in a metal molar ratio of Ni:Co:Mn=0.8:0.1:0.1 and added with pure water to prepare a metal solution with a concentration of 2.0 mol/L; a sodium hydroxide solution with a concentration of 30% was prepared to obtain an alkali liquor; and ammonia water with a concentration of 20% was prepared.
(2) Preparation of a seed crystal: Pure water was added to a seed crystal reactor, heating and stirring were started, and when a temperature reached 65° C., the metal solution, the alkali liquor, and the ammonia water were simultaneously fed to prepare the seed crystal, where a temperature in the reactor remained unchanged through a temperature control system; a flow rate of the alkali liquor was adjusted to make a pH in the reactor fluctuate within a range of 10 to 12 and a flow rate of the ammonia water was adjusted to control an ammonia concentration in the reactor at about 1.0 g/L; a particle size in the reactor continued to grow, and when the particle size reached 4.0 μm, the pH was increased to produce small particles to reduce the particle size; this adjustment process was repeated to stabilize the particle size of the seed crystal at about 4.0 μm; and a qualified seed crystal slurry obtained was centrifuged in a centrifuge for dewatering, and then sealed and stored in a barrel.
(3) Continuous production: A specified amount of the seed crystal was fed into a growth reactor, water was added, heating and stirring were started, and when a temperature reached 65° C., the metal solution, the alkali liquor, and the ammonia water were simultaneously fed in a protective nitrogen atmosphere to prepare the radially-structured nickel-based precursor, where a temperature in the reactor remained unchanged through a temperature control system; a flow rate of the alkali liquor was adjusted to stabilize a pH in the reactor at about 10.8 and a flow rate of the ammonia water was adjusted to control an ammonia concentration in the reactor at about 3.0 g/L; a particle size in the reactor continued to grow, and when the particle size reached 7.0 μm, a dry seed crystal was fed while overflowing to reduce a particle size and keep an overall solid content in the reactor unchanged; the particle size adjustment process was repeated to maintain a precursor particle size at about 7.0 μm, thereby achieving continuous production; and a qualified product was collected, washed, dewatered, and dried to obtain the radially-structured nickel-based precursor Ni_{0.8}Co_{0.1}Mn_{0.1}(OH)₂ with an average particle size of 7.0 μm.

### Example 2

In this example, a radially-structured nickel-based precursor was prepared, and a specific preparation process was as follows:
(1) Preparation of feed solutions: Nickel sulfate, cobalt sulfate, manganese sulfate, and aluminum sulfate were mixed in a metal molar ratio of Ni:Co:Mn:Al=0.82:0.12:0.05:0.01 and added with pure water to prepare a metal solution with a concentration of 1.9 mol/L; a sodium hydroxide solution with a concentration of 30% was prepared to obtain an alkali liquor; and ammonia water with a concentration of 20% was prepared.
(2) Preparation of a seed crystal: Pure water was added to a seed crystal reactor, heating and stirring were started, and when a temperature reached 60° C., the metal solution, the alkali liquor, and the ammonia water were simultaneously fed to prepare the seed crystal, where a temperature in the reactor remained unchanged through a temperature control system; a flow rate of the alkali liquor was adjusted to make a pH in the reactor fluctuate within a range of 10 to 12 and a flow rate of the ammonia water was adjusted to control an ammonia concentration in the reactor at about 4.0 g/L; a particle size in the reactor continued to grow, and when the particle size reached 4.0 μm, the pH was increased to produce small particles to reduce the particle size; this adjustment process was repeated to stabilize the particle size of the seed crystal at about 4.0 μm; and a qualified seed crystal slurry obtained was centrifuged in a centrifuge for dewatering, and then sealed and stored in a barrel.
(3) Continuous production: A specified amount of the seed crystal was fed into a growth reactor, water was added, heating and stirring were started, and when a temperature reached 60° C., the metal solution, the alkali liquor, and the ammonia water were simultaneously fed in a protective nitrogen atmosphere to prepare the radially-structured nickel-based precursor, where a temperature in the reactor remained unchanged through a temperature control system; a flow rate of the alkali liquor was adjusted to stabilize a pH in the reactor at about 10.5 and a flow rate of the ammonia water was adjusted to control an ammonia concentration in the reactor at about 7.0 g/L; a particle size in the reactor continued to grow, and when the particle size reached 8.0 μm, a dry seed crystal was fed while overflowing to reduce a particle size and keep an overall solid content in the reactor unchanged; the particle size adjustment process was repeated to maintain a precursor particle size at about 8.0 μm, thereby achieving continuous production; and a qualified product was collected, washed, dewatered, and dried to obtain the radially-structured nickel-based precursor Ni_{0.82}Co_{0.12}Mn_{0.05}Al_{0.01}(OH)₂ with an average particle size of 8.0 μm.

### Example 3

In this example, a radially-structured nickel-based precursor was prepared, and a specific preparation process was as follows:
(1) Preparation of feed solutions: Nickel sulfate, cobalt sulfate, and magnesium sulfate were mixed in a metal molar ratio of Ni:Co:Mg=0.9:0.08:0.02 and added with pure water to prepare a metal solution with a concentration of 2.0 mol/L; a sodium hydroxide solution with a concentration of 30% was prepared to obtain an alkali liquor; and ammonia water with a concentration of 20% was prepared.
(2) Preparation of a seed crystal: Pure water was added to a seed crystal reactor, heating and stirring were started, and when a temperature reached 70° C., the metal solution, the alkali liquor, and the ammonia water were simultaneously fed to prepare the seed crystal, where a temperature in the reactor remained unchanged through a temperature control system; a flow rate of the alkali liquor was adjusted to make a pH in the reactor fluctuate within a range of 10 to 12 and a flow rate of the ammonia water was adjusted to control an ammonia concentration in the reactor at about 2.0 g/L; a particle size in the reactor continued to grow, and when the particle size reached 3.5 μm, the pH was increased to produce small particles to reduce the particle size; this adjustment process was repeated to stabilize the particle size of the seed crystal at about 3.5 μm; and a qualified seed crystal slurry obtained was centrifuged in a centrifuge for dewatering, and then sealed and stored in a barrel.
(3) Continuous production: A specified amount of the seed crystal was fed into a growth reactor, water was added, heating and stirring were started, and when a temperature reached 70° C., the metal solution, the alkali liquor, and the ammonia water were simultaneously fed in a protective nitrogen atmosphere to prepare the radially-structured nickel-based precursor, where a temperature in the reactor remained unchanged through a temperature control system; a flow rate of the alkali liquor was adjusted to stabilize a pH in the reactor at about 10.4 and a flow rate of the ammonia water was adjusted to control an ammonia concentration in the reactor at about 8.0 g/L; a particle size in the reactor continued to grow, and when the particle size reached 7.0 μm, a dry seed crystal was fed while overflowing to reduce a particle size and keep an overall solid content in the reactor unchanged; the particle size adjustment process was repeated to maintain a precursor particle size at about 7.0 μm, thereby achieving continuous production; and a qualified product was collected, washed, dewatered, and dried to obtain the radially-structured nickel-based precursor Ni_{0.9}Co_{0.08}Mg_{0.02}(OH)₂ with an average particle size of 7.0 μm.

### Comparative Example 1

In this comparative example, a precursor was prepared, and a specific preparation process was as follows:
(1) Preparation of feed solutions: Nickel sulfate, cobalt sulfate, manganese sulfate, and aluminum sulfate were mixed in a metal molar ratio of Ni:Co:Mn:Al=0.82:0.12:0.05:0.01 and added with pure water to prepare a metal solution with a concentration of 1.9 mol/L; a sodium hydroxide solution with a concentration of 30% was prepared to obtain an alkali liquor; and ammonia water with a concentration of 20% was prepared.
(2) Pure water was added to a reactor, heating and stirring were started, and when a temperature reached 65° C., the metal solution, the alkali liquor, and the ammonia water were simultaneously fed to prepare the precursor, where a temperature in the reactor remained unchanged through a temperature control system; a flow rate of the alkali liquor was adjusted to control a pH in the reactor at about 10.8 and a flow rate of the ammonia water was adjusted to control an ammonia concentration in the reactor at about 3.0 g/L; a particle size in the reactor continued to grow, and when the particle size reached 8.0 μm, the pH was increased to produce small particles to reduce the particle size; this adjustment process was repeated to stabilize the particle size of the product at about 8.0 μm; and a qualified product was collected, washed, dewatered, and dried to obtain the precursor 1 of this comparative example.

### Comparative Example 2

In this comparative example, a precursor was prepared, and a specific preparation process was as follows:
(1) Nickel sulfate, cobalt sulfate, and manganese sulfate were mixed in a metal molar ratio of Ni:Co:Mn=0.8:0.1:0.1 and added with pure water to prepare a metal solution with a concentration of 2.0 mol/L; a sodium hydroxide solution with a concentration of 30% was prepared to obtain an alkali liquor; and ammonia water with a concentration of 20% was prepared.
(2) Water was added to a growth reactor, heating and stirring were started, and when a temperature reached 60° C., the metal solution, the alkali liquor, and the ammonia water were simultaneously fed in a protective nitrogen atmosphere to prepare the precursor, where a temperature in the reactor remained unchanged through a temperature control system; a flow rate of the alkali liquor was adjusted to stabilize a pH in the reactor at about 10.9 and a flow rate of the ammonia water was adjusted to control an ammonia concentration in the reactor at about 6.0 g/L; a particle size in the reactor continued to grow, and when the particle size reached 8.0 μm, the pH was increased to produce small particles to reduce the particle size; this adjustment process was repeated to stabilize the particle size of the product at about 8.0 μm; and a qualified product was collected, washed, dewatered, and dried to obtain the precursor 2 of this comparative example.

### Comparative Example 3

In this comparative example, a precursor was prepared, and a specific preparation process was as follows:
(1) Nickel sulfate, cobalt sulfate, and magnesium sulfate were mixed in a metal molar ratio of Ni:Co:Mg=0.9:0.08:0.02 and added with pure water to prepare a metal solution with a concentration of 2.0 mol/L; a sodium hydroxide solution with a concentration of 30% was prepared to obtain an alkali liquor; and ammonia water with a concentration of 20% was prepared.
(2) Water was added to a growth reactor, heating and stirring were started, and when a temperature reached 70° C., the metal solution, the alkali liquor, and the ammonia water were simultaneously fed in a protective nitrogen atmosphere to prepare the precursor, where a temperature in the reactor remained unchanged through a temperature control system; a flow rate of the alkali liquor was adjusted to stabilize a pH in the reactor at about 10.5 and a flow rate of the ammonia water was adjusted to control an ammonia concentration in the reactor at about 3.0 g/L; a particle size in the reactor continued to grow, and when the particle size reached 7.0 μm, the pH was increased to produce small particles to reduce the particle size; this adjustment process was repeated to stabilize the particle size of the product at about 7.0 μm; and a qualified product was collected, washed, dewatered, and dried to obtain the precursor 3 of this comparative example.

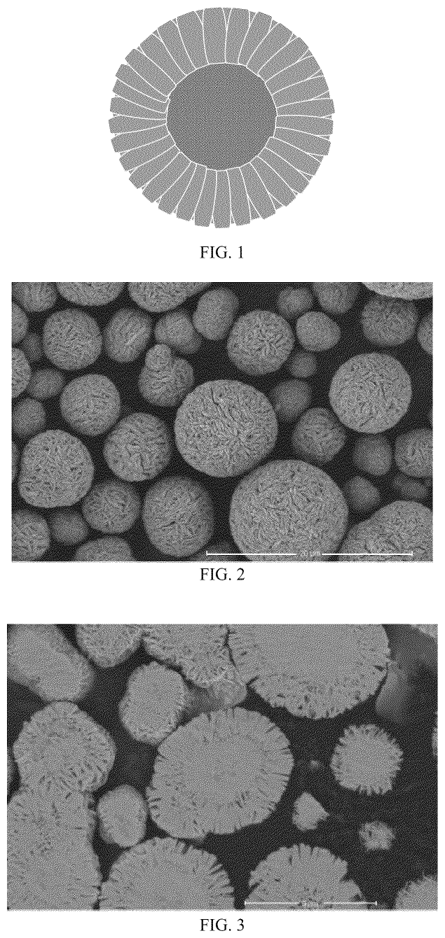

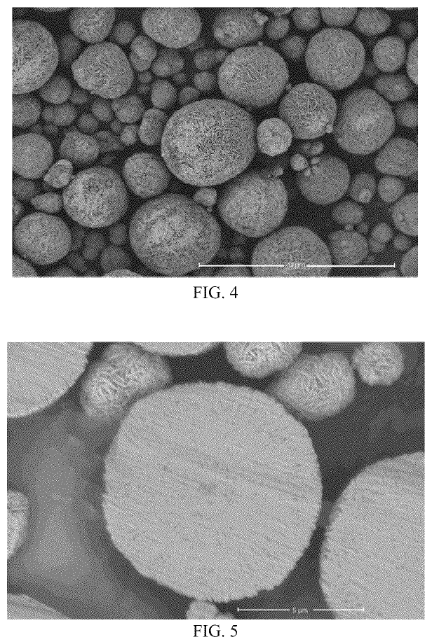

FIG. 1 is a schematic structural diagram of the precursor of Example 1 of the present invention. FIG. 2 and FIG. 4 are SEM images of the precursors of Example 1 and Comparative Example 1, respectively, and it can be seen from the SEM images that the precursors of Example 1 and Comparative Example 1 are both spherical particles. FIG. 3 and FIG. 5 are SEM images of the cross-sections of the precursors of Example 1 and Comparative Example 1, respectively, and it can be seen from the cross-sections that there a significant difference between the structures of the two. The particles in FIG. 3 present an obvious core-shell structure, where a loose and porous network core is formed inside, which has a diameter accounting for more than ½ of a diameter of an entire sphere; and uniform and regular thick strip primary crystal grains are formed outside, which grow outward perpendicularly to a surface of the crystal nucleus and are arranged radially and closely. FIG. 5 shows messy filamentous primary crystal grains without obvious radial characteristics.

The examples of present invention are described in detail with reference to the accompanying drawings, but the present invention is not limited to the above examples. Within the scope of knowledge possessed by those of ordinary skill in the technical field, various changes can also be made without departing from the purpose of the present invention. In addition, the examples in the present invention or features in the examples may be combined with each other in a non-conflicting situation.

1. A radially-structured nickel-based precursor, wherein an overall shape of the precursor is a secondary sphere formed by aggregation of primary crystal grains; the secondary sphere has a loose and porous network core inside, and has a uniform and regular strip-shaped primary crystal grains outside, and the strip-shaped primary crystal grains grow outward perpendicularly to a surface of the core and are arranged radially and closely; and the precursor has a chemical formula of NiₓCo_{y}Mn_{z}M_{(1-x-y-z})(OH)₂, wherein 0.5≤x<1, 0≤y≤0.5, 0≤z≤0.5, and M is a doping element; a diameter of the core of the precursor accounts for more than ½ of a diameter of an entire precursor particle;
the radially-structured nickel-based precursor is prepared by the following method, comprising the following steps:
(1) adding a metal solution, an alkali liquor, and ammonia water to a first reactor, and heating and stirring to allow a reaction to prepare a seed crystal, during the reaction controlling the pH within a range of 9 to 12, and controlling the ammonia concentration in the at 0 to 5 g/L, and continuously feeding the metal solution, the alkali liquor, and the ammonia water until a particle size reaches a target value of the seed crystal; and
(2) adding the seed crystal, the metal solution, the alkali liquor, and the ammonia water to a second reactor, and heating and stirring to allow a reaction, during the reaction, controlling the pH at 9 to 12, controlling an ammonia concentration in the reaction system at 5 to 10 g/L, and continuously feeding the metal solution, the alkali liquor, and the ammonia water until a particle size reaches a target value of the precursor to obtain a product; and collecting, washing, dewatering, and drying the product to obtain the radially-structured nickel-based precursor;
wherein the metal solution comprises a nickel salt and one or two selected from the group consisting of a cobalt salt and a manganese salt.

2. The radially-structured nickel-based precursor according to claim 1, wherein the precursor has an average particle size of 3 to 10 μm.

3. The radially-structured nickel-based precursor according to claim 1, wherein M is one or more from the group consisting of Al, Mg, W, Zr, and Ti.

4. The radially-structured nickel-based precursor according to claim 1, wherein total metals in the metal solution have a molar concentration of 1.0 to 2.5 mol/L.

5. The radially-structured nickel-based precursor according to claim 1, wherein the metal solution further comprises a doped metal salt, and the doped metal salt is one or more selected from the group consisting of aluminum sulfate, aluminum nitrate, sodium aluminate, magnesium sulfate, magnesium nitrate, magnesium chloride, sodium tungstate, tungsten trioxide, zirconium sulfate, zirconium nitrate, titanium chloride, titanic acid, and titanium tetrachloride.

6. The radially-structured nickel-based precursor according to claim 1, wherein in step (1), when the particle size reaches the target value of the seed crystal, the pH is increased to make a new crystal nucleus grow, such that a particle size of the seed crystal in the reactor can be always kept around the target value.

7. The radially-structured nickel-based precursor according to claim 1, wherein in step (2), when the particle size reaches the target value of the precursor, the seed crystal is fed while overflowing to maintain a solid content in the reactor relatively stable, such that a particle size of the precursor in the reactor can be always kept around the target value.

8. The radially-structured nickel-based precursor according to claim 1, wherein in steps (1) and/or (2), the heating is conducted at 50-80° C.
